(19) United States
(12) Patent Application Publication
(10) Pub. No.: US 2004/0152581 A1
(43) Pub. Date: Aug. 5, 2004

(54) Ceramic article and method of manufacture therefor

(76) Inventors: Bruce Paul Bardes, Montgomery, OH (US); Robert Dzugan, Cincinnati, OH (US)

Correspondence Address: Bruce P. Bardes, c/o Hasse, Guttag & Nesbitt LLC, Suite 316, 7577 Central Park Blvd., Mason, OH, 45040, US

(21) Appl. No.: 10/357,053

(22) Filed: Feb. 3, 2003

(51) Int. Cl. B29C 35/04; C04B 35/14; C04B 35/80

(52) U.S. Cl. 501/95.2; 264/401; 264/497; 501/133

(57) ABSTRACT

A ceramic article resulting from a chemical interaction between a particulate ceramic material and a ceramic matrix material is described. The ceramic matrix results from at least partial chemical transformation of a precursor material. A chemical bond between the ceramic matrix and the particulate ceramic material is developed during manufacture. The configuration of the ceramic article is developed through use of a rapid prototyping process. A ceramic article comprising different compositions in two or more regions of the article is described. A manufacturing process comprising the steps employed to produce such a ceramic article is also described.

The ceramic article described herein is particularly suited for use as a mold for metal casting. The manufacturing process disclosed herein enables production of such a mold within a matter of hours, rather than days, as required by prior art casting technologies.

### BACKGROUND OF THE INVENTION

1. Field of the Invention

This invention relates generally to ceramic articles and methods for the manufacture thereof. The invention is particularly suited for use in manufacturing ceramic molds for metal casting processes.

2. Description of Related Art

The origins of many of the commonly used methods of manufacturing ceramic articles have been lost in antiquity. Naturally, many of these methods have been updated over the years, but the essential elements of many methods of manufacturing ceramic articles haven't changed very much in centuries. Most of the common methods employ a vehicle, typically water, for facilitating manipulation of ceramic particles into whatever configuration is appropriate to a particular application. In their textbook, “Manufacturing Engineering and Technology” (Fourth Edition), Kalpakjian and Schmid identify three groups of ceramic manufacturing methods: casting, plastic forming and pressing. All of the manufacturing methods in the casting and plastic forming groups, and about half of the methods in the pressing group employ a vehicle such as water; these may be termed wet methods. In terms of the tonnage of ceramic articles produced by these methods, the overwhelming majority is produced by wet methods. The processing methods that do not employ a vehicle, or dry methods, are analogous to powder metallurgy methods.

Wet methods for manufacturing ceramic articles contain steps that remove the vehicle essential to the manufacturing process. Those steps may include drying at a relatively low temperature to evaporate most of the vehicle, and baking at a higher temperature to evaporate the remaining vehicle. Where water is the vehicle, drying typically occurs below 212° F. (100° C.), so that the water does not boil, which could cause a ceramic article to literally explode. Water present in ceramic articles may be present as a vehicle, or as water of hydration. Removal of such water is a slow process, particularly if the ceramic article has substantial thickness. In a subsequent manufacturing step, a ceramic article is typically fired at a much higher temperature, thereby creating strong bonds between adjacent ceramic particles.

Dry methods for manufacturing ceramic articles contain steps that simply press the ceramic particles together under high pressure. The pressing can be done at room temperature, or at temperatures high enough for diffusion of the atomic or ionic species present in the ceramic to be appreciable. In the latter case, no subsequent firing is necessary. Where pressing is done at room temperature, it is followed by sintering, which consolidates the powder into a dense article.

During drying, firing or hot pressing operations, a ceramic article can shrink as much as 20 percent. Such shrinkage can be a significant problem if the nature of the ceramic article mandates close dimensional tolerances.

Although it has much broader utility, the present invention is particularly applicable to ceramic molds for metal casting operations. In such applications, the slow process of removing water from the ceramic can significantly lengthen the process of developing a new product. Someone designing a cast product may have to wait several days to see a pilot model of whatever he has designed. The same lengthy cycle is required for each iteration in the development of a product.

Kalpakjian and Schmid describe many casting processes, but three such processes are germane to the present discussion: plaster-mold casting, ceramic-mold casting and investment casting. In plaster-mold casting, a slurry of plaster of Paris and other ingredients is poured over a pattern representing the configuration of one half of the finished part. The resulting half-mold is allowed to dry. The pattern is then removed from the half-mold. A mating half-mold is made in a similar fashion. The manufacture of a mold for ceramic-mold casting is similar, except that the slurry contains ceramic particles selected for their resistance to the high temperatures characteristic of metal casting operations, plus an organic binder that holds the ceramic particles in position until firing. Note that in either process, casting design is limited by the requirement for removing the pattern, which is typically made from aluminum, brass, plastic and the like.

In the investment casting process, a disposable pattern is made from a material such as wax or plastic. The pattern is then embedded in a ceramic investment. The investment can be in the form of a plaster mold, or it can be a shell of multiple layers of ceramic material. The latter version of the process provides higher temperature capability than a plaster investment. It is therefore preferred for many applications, even though a period of ten days can be required to make a mold. The investment casting process has been known in the Far East for more than 4000 years.

Given the desirability of manufacturing articles as quickly as possible, particularly in the contexts of product development and custom product design, there has been a continuing search for more rapid methods for making articles. Such methods can be collectively identified as rapid prototyping (RP) methods. Kalpakjian and Schmid have identified seven such RP methods, each involving the addition of material to the object being manufactured.

One example of how rapid prototyping can be employed to accelerate development of new products is the use of stereolithography (SLA) to make patterns for investment casting. SLA was developed by Hull (U.S. Pat. No. 4,575,330). In a common embodiment of the SLA process, a thin film of liquid photosensitive polymer resin is spread on a build table. A localized spot of light, preferably a laser beam, is moved over the film of resin, causing polymerization of the resin wherever the light strikes it. After achieving polymerization in all desired regions of this layer of resin, the build table is lowered into a vat of resin, a new layer of resin is spread over the first layer, and the process is repeated. Movement of the spot of light is controlled by a computer system, which causes beam movements corresponding to the configuration of the desired workpiece, as defined in a computer-aided drafting (CAD) file. While SLA is useful in making a pattern for investment casting, it does not address the matter of making a mold for investment casting. In an alternate form of the SLA process, the workpiece is lifted from a shallow bath of resin; polymerization occurs by directing the spot of light through a window at the bottom of the bath.

Crump (U.S. Pat. Nos. 5,121,329 and 5,340,433) has developed an RP process, which he termed fused deposition modeling (FDM). In the FDM process, a thin filament of thermoplastic or wax material is heated and extruded through a small orifice in a movable deposition head. Molten (or nearly molten) material extruded through the deposition head impinges previously deposited material, and solidifies upon contact therewith. Movement of the deposition head is controlled by a computerized control system.

Deckard (U.S. Pat. No. 5,639,070) has developed another RP process, which he termed selective laser sintering (SLS). In the SLS process, a thin layer of powder is spread over a build table. A laser beam is moved over the layer of powder so that the powder particles are sintered together wherever the laser beam has been aimed. After the desired localized sintering is achieved on the first layer of powder, a second layer of powder is spread over the first, and the process is repeated. Ceramic articles can be made by the SLS process. However, the localized heating to cause sintering can also cause sufficient thermal shock to crack the workpiece. In a variation of the SLS process, Langer et al (U.S. Pat. Nos. 5,460,758 and 6,155,331) have taught the use of powder particles coated with a resin layer. Their teachings indicate that the green strength of a fabricated article can be increased without the thermal stresses that often exist in an article made by the SLS process. However, both the Deckard method and the variation described by Langer et al are vulnerable to considerable shrinkage during manufacture.

Sachs et al (U.S. Pat. No. 5,204,055) have developed yet another RP process, which they termed three-dimensional printing (3D printing). In the 3D printing process, a thin layer of powder is spread over a build table. A liquid binder material is selectively deposited over designated regions of the layer of powder. A print head generally similar in function to a computer ink jet printer is useful for depositing the binder. After deposition of binder on the first layer of powder has been completed, a second layer of powder is spread over the first, and the process is repeated. After the entire article has been thusly created, it is sintered to achieve whatever densification is appropriate. Ceramic articles can be made by the 3D printing process. However, considerable shrinkage can occur during sintering, so that an article that is dense enough to have useful strength can be too distorted to serve its intended function. Kalpakjian and Schmid disclose that in a variation on the 3D printing process, the binder liquid can contain colloidal silica particles. However, this variation is still subject to shrinkage during sintering.

Notwithstanding advocates of SLS and 3D printing, none of the above-referenced RP technologies, nor any other known RP technology, is fully appropriate for the manufacture of ceramic metal casting molds.

Szweda, Millard and Harrison (U.S. Pat. Nos. 5,306,554, 5,488,017 and 5,601,674) teach a method for developing a ceramic matrix for a composite material comprising ceramic reinforcing fibers in a ceramic matrix. Specifically, Szweda et al teach the use of a silicone resin precursor as a means of achieving a ceramic matrix that is substantially silica and/or silicates. For their application, it was desirable that the entire composite article would be laid up in its intended configuration before the silicone resin precursor was transformed to a ceramic matrix. The context of the present invention, namely, fabricating a ceramic mold for metal casting, preferably by RP technology, working from a CAD file of the finished part, presented process requirements that were significantly contrary to the problems addressed by Szweda et al.

### SUMMARY OF THE INVENTION

Briefly, the present invention provides a ceramic article that can be produced in a short time, employing a novel combination of chemical transformations and rapid prototyping processes. The key feature of the invention is the use of a precursor material that is amenable to processing by one of a variety of rapid prototyping processes. The precursor material is typically provided as a liquid that can be transformed to a solid, either during or immediately following fabrication of an article by a rapid prototyping process. This attribute of the precursor material can be achieved by employing a monomeric resin that is polymerized during processing. The polymerized resin is subsequently transformed into a ceramic matrix material, preferably by oxidation. Particulate ceramic material that had been intermixed with the liquid precursor material becomes embedded in the ceramic matrix material. Further chemical interaction between the particulate ceramic material and the ceramic matrix material develops a chemical bond therebetween. Still further chemical interaction therebetween can create a new chemical species. The sequence of chemical interactions typically results in transformation of substantially all of the precursor material into ceramic matrix material. Depending upon the nature of the specific materials selected for a particular application, formation of the new chemical species may consume part, or all, of either the particulate ceramic material or the ceramic matrix material.

In one embodiment of the present invention, the precursor material is a photosensitive silicone resin. The preferred resin has low enough viscosity that is can be conveniently processed as a liquid, prior to polymerization. Polymerization of the resin is initiated by exposure to ultraviolet light. Upon exposure of the polymerized silicone resin to air at a moderately elevated temperature, it is oxidized to form silica and/or silicates, and gaseous byproducts such as water vapor and carbon dioxide. The resulting silica exists as a matrix that surrounds and supports particulate ceramic material that had been intermixed with the monomeric form of the precursor resin material. Further treatment of this product at an elevated temperature can cause the silica matrix to interact with the particulate ceramic material. A variety of particulate ceramic materials, and even mixtures of two or more particulate ceramic materials can be employed, depending on the nature of the intended application of the resulting ceramic article.

The process disclosed herein may use several rapid prototyping processes, and variations thereof. Several embodiments of the present invention, each relating to a particular RP process, are described hereinbelow. Each of these embodiments of the present invention offers certain advantages. However, the same fundamental chemical interactions and transformations occur during each embodiment of the process. Thus, the process of the present invention must be viewed broadly, to encompass these, and other, rapid prototyping processes.

One particularly useful application of the ceramic article of the present invention is as a mold for casting metallic articles. Through the technology disclosed herein, a ceramic mold can be produced in a matter of hours, rather than the several days that might be required to produce such a mold by conventional investment casting technology. Further, a mold made by the process of the present invention can have a core as an integral part thereof, thus avoiding the need for a separate core, as is required in conventional investment casting technology.

Specific features of the ceramic article of the present invention are detailed in the following Detailed Description of the Invention and the accompanying drawings. Several embodiments of the present invention are also described therein. Those having ordinary skill in the ceramic and metal casting arts will recognize alternative means for practicing the present invention, all of which are deemed to be equivalent to and to fall within the scope of the present invention.

### DESCRIPTION OF THE DRAWING

FIG. 1 is a schematic representation of the process of the present invention, showing particulate ceramic material and precursor material, transformation of the precursor material to a ceramic matrix material, and chemical interaction between the particulate ceramic material and the ceramic matrix material to form a new chemical species.

### DETAILED DESCRIPTION OF THE INVENTION

Several prior art casting and rapid prototyping processes have been described hereinabove. Understanding these examples of prior art is deemed useful in understanding the present invention. Note that the prior art casting processes described hereinabove include drying operations, where water contained in ceramic molds made by wet ceramic processes is removed. Such drying operations are very time-consuming, typically requiring several days. The processes of the present invention eliminate or significantly reduce the drying time associated with these prior-art casting processes.

The ceramic article of the present invention is advantageously described with reference to the FIGURE described hereinabove. The manufacturing process for that ceramic article is likewise advantageously described with reference to the FIGURE.

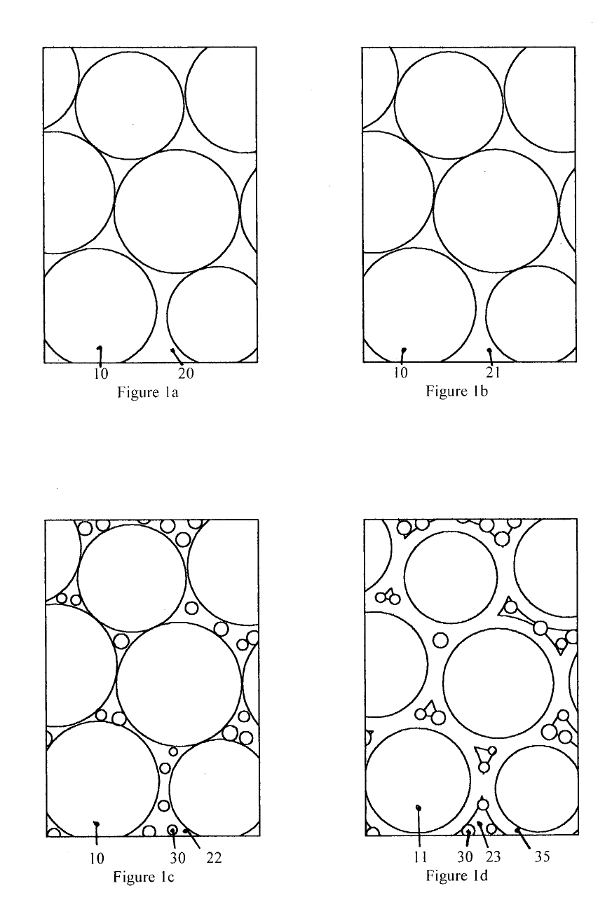

The chemical transformations that typically occur during practice of the present invention are illustrated in FIG. 1, which comprises four schematic micrographs of the same region in a material as it might exist at various stages of the process. FIG. 1a illustrates the intermixed combination of particulate ceramic material 10 and monomeric precursor material 20. Note that the precursor material is in intimate contact with the particulate ceramic material. FIG. 1b illustrates the effect of polymerizing the precursor material 20 shown in FIG. 1a to a polymer matrix material 21. FIG. 1c illustrates the chemical transformation of the polymer matrix material 21 shown in FIG. 1b to a ceramic matrix material 22. Using the process and materials described herein, and perhaps other materials as well, a chemical bond between the ceramic matrix material 22 and the particulate ceramic material 10 is achieved thereby. The transformation typically produces gaseous byproducts such as water vapor and carbon dioxide; pores 30 are typically formed during the transformation. FIG. 1d illustrates the formation of a new chemical species 35 from reaction of the particulate ceramic material 10 with the ceramic matrix material 22. In FIG. 1d, pockets of unreacted particulate ceramic material are shown at 11 and pockets of unreacted ceramic matrix material are shown at 23. For simplicity, it assumed that the size, shape and distribution of pores 30 are unaffected by the formation of the new chemical species 35. This assumption is an oversimplification, for the chemical diffusion necessary to achieve the formation of a new chemical species is quite sufficient to achieve movement, shape change and even consolidation of the pores.

In one presently preferred embodiment of the present invention, the monomeric precursor material 20 is a low-viscosity silicone resin. The resin also contains a photosensitive substance that initiates polymerization of the resin when it is exposed to light, preferably ultraviolet light. Even though the resin is initially intermixed with particulate ceramic material at the outset of the present manufacturing process, the low viscosity of the resin makes the resulting mixture amenable to processing by SLA technology, in a manner similar to that described by Hull. Because monomeric silicone resins are typically produced as two separate components, which are mixed together shortly before use, the premixed resin is perishable, having a rather short working life. Accordingly, the inverted embodiment of the SLA process is deemed preferable for the present invention, because a much smaller volume of the perishable precursor material is required in this configuration.

Polymerizing the silicone resin 20 results in a solid substance 21 that has a modest amount of structural strength, at least enough to hold the article being made together for further processing. In the next step of processing, the solid silicone substance 21 is oxidized to form silica and/or silicates, shown at 22. Heating the solid silicone substance 21 in air at temperatures in the range of 1100-1400° F. (550-750° C.) is generally sufficient for this purpose. The preferred temperature depends upon many factors, including the specific silicone resin employed in the process, size of the workpiece, and acceptable distribution of porosity 30 in the workpiece. Temperatures at the high end of this range favor rapid oxidation, but at the risk of rapid formation of gaseous byproducts such as steam and carbon dioxide, and such rapid formation may cause unacceptably large pores and/or damage to the ceramic article. Further heating, at a higher temperature, can cause the silica 22 to react with the particulate ceramic material 10 to form a new chemical species 35. If the particulate ceramic material is alumina, the new chemical species will be mullite. The appropriate temperature for this reaction depends on what material(s) comprises the particulate ceramic material 10. According to Szweda et al, temperatures as high as 2550° F. (1400° C.) may be appropriate. It should be noted that if the intended application of the ceramic article admits to a structure comprising ceramic particles in a matrix of silica, this last step could be omitted from the process. However, silica softens at relatively low temperatures, much lower than mullite, for example, so that interaction between alumina particles with a silica matrix to produce mullite is useful in extending the high temperature capability of the completed ceramic article.

In the context of the present invention, it is contemplated that substances other than silicone resin can be incorporated in the precursor material. For example, Szweda et al have shown the utility of mixing a moderate percentage of an epoxy resin into the silicone resin. Other precursor materials that transform to ceramic materials such as alumina can be mixed into the silicone resin.

As indicated above, and illustrated in FIG. 1, the monomeric precursor material 20 is intermixed with particulate ceramic material. That ceramic material can be a mixture of two or more chemical species. Under most circumstances, the particulate ceramic material will be comprised primarily of the species that will become an essential component of the completed ceramic article. In a presently preferred embodiment of the present invention, that essential component is alumina. However, a wide variety of other particulate materials can be employed. For example, the use of silica particles can result in a ceramic article that is predominantly silica.

The preferred size of the particulate ceramic material depends on several factors. It is essential that the individual ceramic particles must be smaller than the thickness of the layer of precursor material applied to the build table. That thickness is typically about 5 mils or less. [One mil is 0.001 inch, or 25 micrometers, or microns.] Unduly small ceramic particles create problems in handling. For the purposes of the present invention, it is believed that a preferred particle size lies between about 0.03 mil (0.75 micron) in diameter and about 3 mils (75 microns) in diameter. It is believed that a more preferred particle size lies between about 0.04 mil (I micron) and about 2 mils (50 microns).

Other species of particulate ceramic material can be employed in the method of the present invention. For some purposes, it can be useful to provide multiple chemical species in the particulate ceramic material 10 that subsequently react with silica, specifically to produce a final structure that is a three-component ceramic compound, or a structure comprising two or more distinct phases. Also, Szweda et al have taught that minerals having a lathy-type structure, notably pyrophyllite, are very useful in controlling shrinkage that can occur during high temperature processing.

Another embodiment of the present invention incorporates an RP process similar to 3D printing. In this embodiment, particulate ceramic material is spread on a build table, and droplets of silicone resin are “printed” wherever needed to create solid material in the finished part. The intermixing of precursor material and particulate ceramic material occurs at this point. The silicone resin is then polymerized by flooding the entire printed layer with light, preferably ultraviolet light. The method of the present invention differs from that of Sachs et al, in that Sachs et al teach the use of a binder that is largely evaporated or burned up in subsequent processing, leaving little or no useful material to be incorporated into the ceramic article, whereas the present process employs a precursor that becomes an integral component of the ceramic article.

In another embodiment of the present invention, the particulate ceramic materials are provided as very small particles, between about 0.0004 mil (0.01 micron) and 0.4 mil (10 microns) in diameter. These particles are intermixed with the precursor material, and the mixture is deposited onto a build table (or a previously printed layer) by a printer that is generally similar to an ink jet computer printer. After each layer is deposited, it is bathed in light, preferably ultraviolet light, to polymerize the precursor material. Although this embodiment permits the use of rapid printing technology, for computer printers routinely provide printing rates of 10 pages per minute, the effective build rate of this embodiment is limited by the thickness of each deposited layer. This embodiment bears some similarity to both FDM and 3D printing processes, but is distinct from either.

In the context of the present invention, the precursor material is intermixed with the particulate ceramic material, to bring the two substances into intimate contact. In theory, the term “intimate contact” would imply that each individual ceramic particle would be completely coated with precursor material. However, achieving such a condition in a production manufacturing process is, practically speaking, impossible. Thus, the term “intimate contact” must be interpreted broadly, to indicate that reasonable efforts to intermix the precursor material and particulate ceramic material are taken. It is assumed that intimate contact is achieved in the FDM and 3D printing process, as described above. The term is also taken to include the possibility that wetting agents to facilitate such intimate contact can be included in the precursor material.

Where the porosity in the ceramic article made by the process of the present invention is deemed objectionable, such porosity can be filled using a variety of methods known to those skilled in the ceramic arts. Likewise, a selected portion of the surface of the ceramic article can be coated, either to minimize surface-connected porosity, or to impart some special properties to that portion of the surface. A variety of appropriate methods for surface coating are known to those skilled in the ceramic arts. Although the method mentioned herein are known, the application thereof to the novel ceramic articles of the present invention is novel.

The present invention also contemplates the possibility of depositing at least two different substances during the RP processing. The substances might differ in the combination of chemical species included in the particulate ceramic material, or they might differ in the nature and/or chemical composition of the precursor material. In such an embodiment of the present invention, a variation in mechanical and/or physical properties between different regions of the resulting ceramic article can be achieved. The two different substances can be delivered through a deposition apparatus analogous to the print head of a computer printer capable of color printing. The substances might also be completely different in chemical nature, i.e., one substance can be a mixture of particulate ceramic material and precursor material, as described herein, and the other can be a polymeric material that would be burned away during subsequent processing. The latter would be useful in building a ceramic article that comprises overhanging features that would be unsupported during deposition, but for the presence of a disposable support deposited during the manufacturing process.

One particular class of ceramic articles, namely molds for metal casting, represents a useful embodiment of the present invention. As noted above, several RP technologies can be used for making patterns for investment casting from a polymeric material. The time-consuming process of making a ceramic mold from such a pattern is no different than making a similar mold from a pattern made by any other process. The slow layer-by-layer process for building a mold is still commonly employed. With the process of the present invention, a ceramic mold can be produced directly from a CAD file describing the configuration of the finished metal casting. Current computer technology permits enlarging the size of the finished metal casting to compensate for metal shrinkage during casting. It also permits reversing the sense of the part, so that the exterior surface of the metal casting defines the interior surface of a ceramic mold, and also adding an appropriate thickness to that surface, to define the configuration of a ceramic mold. The process of the present invention is employed to create a ceramic article having a configuration defined by the CAD file containing the aforementioned modifications.

If the configuration of the finished metal casting comprises holes and/or internal passages, conventional metal casting processes typically employ cores to achieve such features. Coremaking is a relatively slow process, and it necessarily precedes the manufacture of any mold with which a core is used. In the course of making a casting of a new design, and that casting requires a core, one must first make a core box, then make a core therefrom. Making a core box is typically expensive and time-consuming. An embodiment of the present invention is a core for virtually any casting process. Although a ceramic core is typically avoided in production casting operations, due to the cost of such a core, making a core in accordance with the present invention within a few hours may outweigh cost considerations, particularly in the context of product development. Also, a core made in accordance with the present invention can be hollow, or comprised of two or more ceramic materials, wherein the surface material could be harder and/or stronger than the interior material. Either of these alternative embodiments can facilitate removal of the core from a finished casting.

In conventional investment casting operations, a wax pattern is typically made by injecting wax into a die cavity that contains a previously fabricated ceramic core. Whenever a core is employed in making a casting, provisions for properly situating that core within the mold cavity must be made. For most casting processes, this typically requires the use of projections on the core itself and mating core prints in the mold cavity. For investment casting, the mating core prints are situated in the die cavity used to make the wax pattern. The process of the current invention admits to the manufacture of mold features corresponding to such holes or internal features simultaneously with manufacture of the mold itself. By permitting in situ fabrication of a core during manufacture of the ceramic mold, the process of the present invention eliminates the time needed to fabricate a separate core, and eliminates the dimensional inaccuracies inherent in situating a core within the mold cavity.

Although the idea of producing a ceramic mold for metal casting by RP technology has been previously disclosed by Sachs et al, and by Kalpakjian and Schmid, the concept of employing a precursor material in lieu of a disposable binder is novel. Note that the use of a precursor material, according to the process of the present invention, materially contributes to controlling dimensions of the completed ceramic mold.

In one embodiment of the present invention, an article to be cast in metal is described in a CAD file. That CAD file is converted into a second computer file, wherein the sense of the second file is reversed, relative to the CAD file. In other words, the second file describes an article containing a cavity that corresponds exactly to the article to be cast. The second file is used to control an RP machine, in which a ceramic article is made. The raw materials for the ceramic article are particulate alumina and a low-viscosity silicone resin. The operation of the RP machine causes the silicone resin to be polymerized, yielding a self-supporting object comprising alumina particles in a silicone matrix. In a first subsequent process, the object is heated in air to about 1250° F., for a time long enough to oxidize the silicone matrix to a silica matrix. In a second subsequent process, the object is heated to a higher temperature, about 2500° F. (1370° C.) for a time sufficient to react the alumina particles with the silica matrix. The result of this chemical interaction is a ceramic structure that is principally comprised of mullite, a reaction product of alumina and silica. The mullite object is appropriate for use as a mold for casting the desired metal article. The entire process is completed within a few days. There is no need to machine a die for molding a wax pattern, and no need to build layer upon layer of ceramic material around the wax pattern. Thus, two time-consuming steps in the conventional investment process are avoided.

While several embodiments of the present invention have been described herein in order to better illustrate the principles and applications thereof, it is understood that various modifications or alterations can be made to the present invention without departing from the true scope of the invention set forth in the appended claims.

We claim:

1. A ceramic article resulting from a chemical interaction between a particulate ceramic material and a ceramic matrix material;
wherein:
the particulate ceramic material and a precursor material are intermixed, so that particles of the particulate ceramic material are in intimate contact with the precursor material;
at least a portion of the precursor material is chemically transformed to form the ceramic matrix material;
the chemical interaction between the particulate ceramic material and the ceramic matrix material produces a chemical bond therebetween; and
the ceramic article has a configuration developed through use of a rapid prototyping process.

2. The ceramic article as recited in claim 1, wherein the chemical interaction produces a new chemical species, consuming at least a portion of the particulate ceramic material and at least a portion of the ceramic matrix material in the chemical interaction.

3. The ceramic article as recited in claim 1, wherein the precursor material is provided in liquid form.

4. The ceramic article as recited in claim 3, wherein the precursor material comprises a silicone resin.

5. The ceramic article as recited in claim 4, wherein the precursor material is chemically transformed by oxidation, and wherein the ceramic matrix material comprises at least one member of a group consisting of silica and silicates.

6. The ceramic article as recited in claim 1, wherein the precursor material is provided in gaseous form.

7. The ceramic article as recited in claim 1, wherein the particulate ceramic material comprises a plurality of chemical species.

8. The ceramic article as recited in claim 1, wherein the precursor material comprises a plurality of chemical species.

9. The ceramic article as recited in claim 1, wherein the rapid prototyping process comprises stereolithography.

10. The ceramic article as recited in claim 1, wherein the rapid prototyping process comprises three-dimensional printing.

11. The ceramic article as recited in claim 1, wherein the rapid prototyping process comprises fused deposition modeling.

12. The ceramic article as recited in claim 1, wherein the rapid prototyping process comprises selective laser sintering.

13. The ceramic article as recited in claim 1, wherein the ceramic article is a core for a metal casting process.

14. The ceramic article as recited in claim 1, wherein the ceramic article is a mold for a metal casting process.

15. The mold for a metal casting process as recited in claim 14, wherein the mold comprises an integral core.

16. A ceramic article resulting from chemical interactions between at least one particulate ceramic material and at least one ceramic matrix material;
wherein:
a first particulate ceramic material and a first precursor material are intermixed, so that particles of the first particulate ceramic material are in intimate contact with the first precursor material, thereby creating a first intermixed material;
at least a portion of the first precursor material is chemically transformed to form a first ceramic matrix material;
the chemical interaction between the first particulate ceramic material and the first ceramic matrix material produces a chemical bond therebetween;
the first intermixed material is employed to manufacture a portion of the ceramic article;
a second particulate ceramic material and a second precursor material are intermixed, so that particles of the second particulate ceramic material are in intimate contact with the second precursor material, thereby creating a second intermixed material;
at least a portion of the second precursor material is chemically transformed to form a second ceramic matrix material;
the chemical interaction between the second particulate ceramic material and the second ceramic matrix material produces a chemical bond therebetween;
the second intermixed material is employed to manufacture a portion of the ceramic article; and
the ceramic article has a configuration developed through use of a rapid prototyping process.

17. The ceramic article as recited in claim 16, wherein the first precursor material and the second precursor material are identical.

18. The ceramic article as recited in claim 16, wherein the first ceramic matrix material and the second ceramic matrix material are identical.

19. The ceramic article as recited in claim 16, wherein first particulate ceramic material and the second particulate ceramic material are identical.

20. The ceramic article as recited in claim 16, wherein the first intermixed material and the second intermixed material comprise the same components, in different proportions.

21. A process for manufacturing a ceramic article, comprising the steps of:
(a) selecting a particulate ceramic material comprising at least one chemical species;
(b) intermixing a precursor material with at least a portion of the particulate ceramic material to achieve intimate contact between the precursor material and the portion of the particulate ceramic material, thereby creating an intermixed material;
(c) shaping the intermixed material into a predetermined configuration by using a rapid prototyping process, thereby creating a preform; and
(d) chemically transforming at least a portion of the precursor material in the preform to a ceramic matrix material.

22. The process as recited in claim 21, wherein the particulate ceramic material comprises alumina.

23. The process as recited in claim 21, wherein the precursor material comprises a resin that is capable of polymerization upon exposure to light.

24. The process as recited in claim 21, wherein the precursor material comprises a silicone resin.

25. The process as recited in claim 21, wherein the rapid prototyping process comprises stereolithography.

26. The process as recited in claim 21, wherein the rapid prototyping process comprises three-dimensional printing.

27. The process as recited in claim 21, wherein the rapid prototyping process comprises fused deposition modeling.

28. The process as recited in claim 21, wherein the rapid prototyping process comprises selective laser sintering.

29. The process as recited in claim 21, wherein chemically transforming at least a portion of the precursor material comprises oxidizing the precursor material.

30. The process as recited in claim 21, additionally comprising the step of chemically interacting at least a portion of the particulate ceramic material with at least a portion of the ceramic matrix material to create the ceramic article.

31. The process as recited in claim 30, wherein chemically interacting at least a portion of the particulate ceramic material with at least a portion of the ceramic matrix material comprises elevated temperature thermal treatment.

32. The process as recited in claim 21, additionally comprising the step of filling porosity in the ceramic article with a filler material.

33. The process as recited in claim 21, additionally comprising the step of coating at least a portion of the ceramic article with a coating material.
